(19) United States
(12) Patent Application Publication
(10) Pub. No.: US 2018/0274231 A1
(43) Pub. Date: Sep. 27, 2018

(54) Flexible Connector Panel for Modular Barrier Systems

(71) Applicants: Stephen T. Epstein, Newtown, PA (US); Michael Nuskey, Holland, PA (US)

(72) Inventors: Stephen T. Epstein, Newtown, PA (US); Michael Nuskey, Holland, PA (US)

(21) Appl. No.: 15/468,270

(22) Filed: Mar. 24, 2017

(51) Int. Cl. E04B 2/74; E05D 1/00

(52) U.S. Cl. CPC E04B 2/7425; E05D 1/00; E04B 2002/7498; E04B 2002/7462; E04B 2002/7479; E04B 2/7429

(57) ABSTRACT

A connector that is used to join a first modular barrier to a second modular barrier. The first modular barrier has a first frame element along one side with a first slot that extends along its length. Likewise, the second modular barrier has a second frame element along one side with a second slot that extends along its length. A flexible panel joins the two modular barriers together. The flexible panel has a first side edge and an opposite and parallel second side edge. The first side edge extends into the first slot of the first frame element and the second side edge extends into the second slot of the second frame element. The first side edge and the second side edge are enlarged and lock the first side edge and the second side edge into the first slot and the second slot, respectively.

### BACKGROUND OF THE INVENTION

### 1. Field of the Invention

In general, the present invention relates to connector systems that are used to interconnect modular barrier panels. More particularly, the present invention relates to connectors that enable modular barrier panels to be interconnected at a variety of intersecting angles.

### 2. Prior Art Description

There are many modular barrier systems that are commercially available. Barrier systems include panels of different shapes and sizes that can be interconnected in a variety of ways. In this manner, the barrier panels can be used to create office cubicles, room dividers, clean rooms, and the like.

In a modular barrier system, the various wall panels are typically framed with metal frame elements. The metal frame elements that form the frame are manufactured by extrusion, wherein grooves extend along the length of each of the frame elements. When the various wall panels are connected together, the frame elements of the different wall panels abut. The frame elements are joined together by rigid mechanical connectors that engage the grooves in the adjacent frames. Such prior art modular barrier systems are exemplified by U.S. Pat. No. 8,839,592 to Foran, entitled “Dust Free Construction Barrier System”.

In many prior art barrier wall panels, the frame elements have a square or rectangular cross-sectional profile. The square shape provides the frame elements with flat surfaces. In this manner, when the frame elements of two wall panels are joined together, the frame elements can abut so that two of the flat surfaces lay flush against each other. This prevents any inadvertent openings from occurring along the joints.

The problem associated with modular barrier wall panels is that the square shape of the frame elements provide for flush connections only when the two wall panels are in-line or at a perpendicular. At all other orientations, the flat surfaces of the frame elements do not lay flush. Angled frame elements can usually be joined at their top ends and bottom ends, but they are not interconnected along their full lengths. As a result, gaps often occur in barrier systems along the joints where two wall panels meet at an acute or obtuse angle.

Small gaps along wall panel joints have little significance if the wall panel joints are being used to form office cubicles or similar structures. However, modular barrier systems are often used in industry to create clean rooms where even a small amount of contamination can be harmful. Likewise, hospitals use modular wall panels to create isolation zones and sanitary zones. Small openings along a joint can allow contamination to travel into, or out of, an isolation zone, therein negating the purpose of the modular barrier system.

A need therefore exists for a system and device that can join together two adjacent modular wall panels at a wide variety of angles, wherein the integrity of the joint is maintained regardless of the angle of connection. The need is met by the present invention as described and claimed below.

### SUMMARY OF THE INVENTION

The present invention is a connector that is used as part of a modular barrier system. The modular barrier system has a first modular barrier and a second modular barrier. The first modular barrier has a first frame element along one side. The first frame element also has a first slot that extends along its length between opposite ends. Likewise, the second modular barrier has a second frame element along one side. The second frame element has a second slot that extends along its length between opposite ends.

A flexible panel joins the two modular barriers together. The flexible panel has a first side edge and an opposite and parallel second side edge. The first side edge extends into the first slot of the first frame element and the second side edge extends into the second slot of the second frame element. The first side edge and the second side edge are enlarged and lock the first side edge and the second side edge into the first slot and the second slot, respectively. This joins the first modular barrier to the second modular barrier while enabling a wide range of orientations between the first modular barrier and the second modular barrier.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of a structure built using a modular barrier system;

FIG. 2 is an enlarged, fragmented view of a segment of the flexible connector panel used within the exemplary structure;

FIG. 3 is a top view of the segment shown in FIG. 2 with the flexible connector panel being in a straight configuration;

FIG. 4 is a top view of the segment shown in FIG. 2 with the flexible connector panel showing its range of flexibility;

FIG. 5 is a top view of an alternate embodiment wherein two flexible connector panels are used to join two modular barriers; and

FIG. 6 is an enlarged, fragmented view of an alternate application of the flexible connector panel.

### DETAILED DESCRIPTION OF THE DRAWINGS

Although the present invention joint system can be embodied in many ways, the embodiment illustrated shows only a few embodiments of the joint system. The exemplary embodiments are selected in order to set forth some of the best modes contemplated for the invention. The illustrated embodiments, however, are merely exemplary and should not be considered limitations when interpreting the scope of the appended claims.

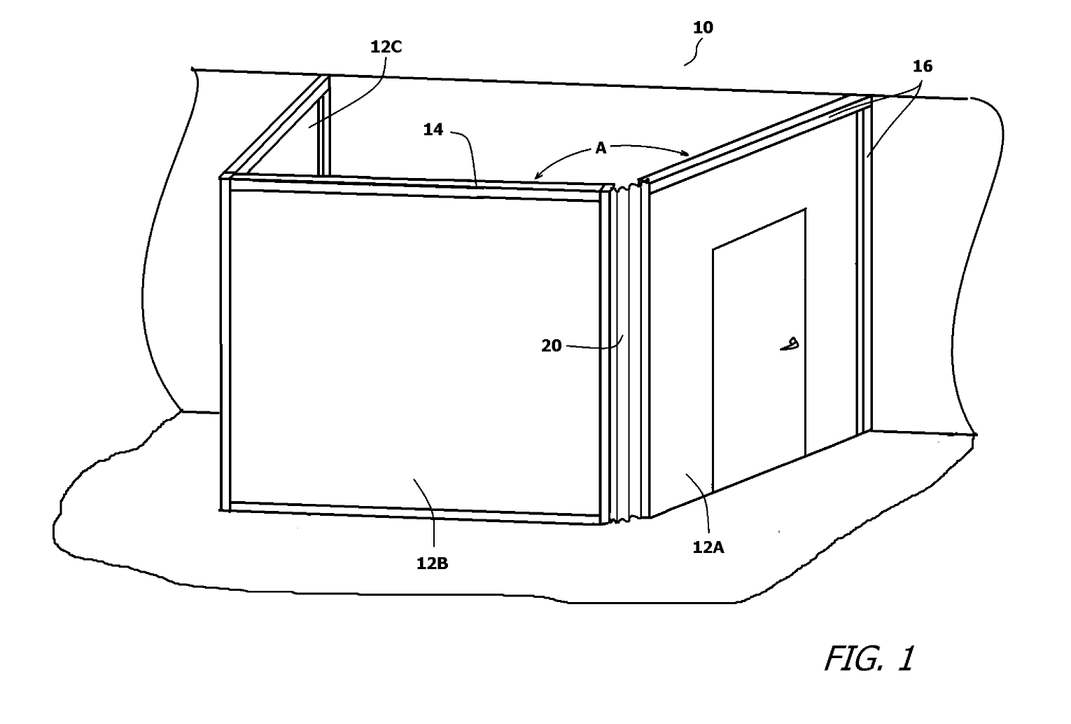

Referring to FIG. 1, an exemplary structure 10 is shown that is comprised of various modular barriers 12A, 12B, 12C. Each of the modular barriers 12A, 12B, 12C has a peripheral frame 14 that is made of frame elements 16. The frame elements 16 are designed to join together either in the same plane or in perpendicular planes. However, as is shown in FIG. 1, a structure 10 can be built with the modular barriers 12A, 12B, 12C, where two of the modular barriers 12A, 12B meet at an acute angle or at an obtuse angle. This is exemplified by angle A in FIG. 1. The present invention is a flexible connector panel 20 that joins two modular barriers 12A, 12B together at any angle.

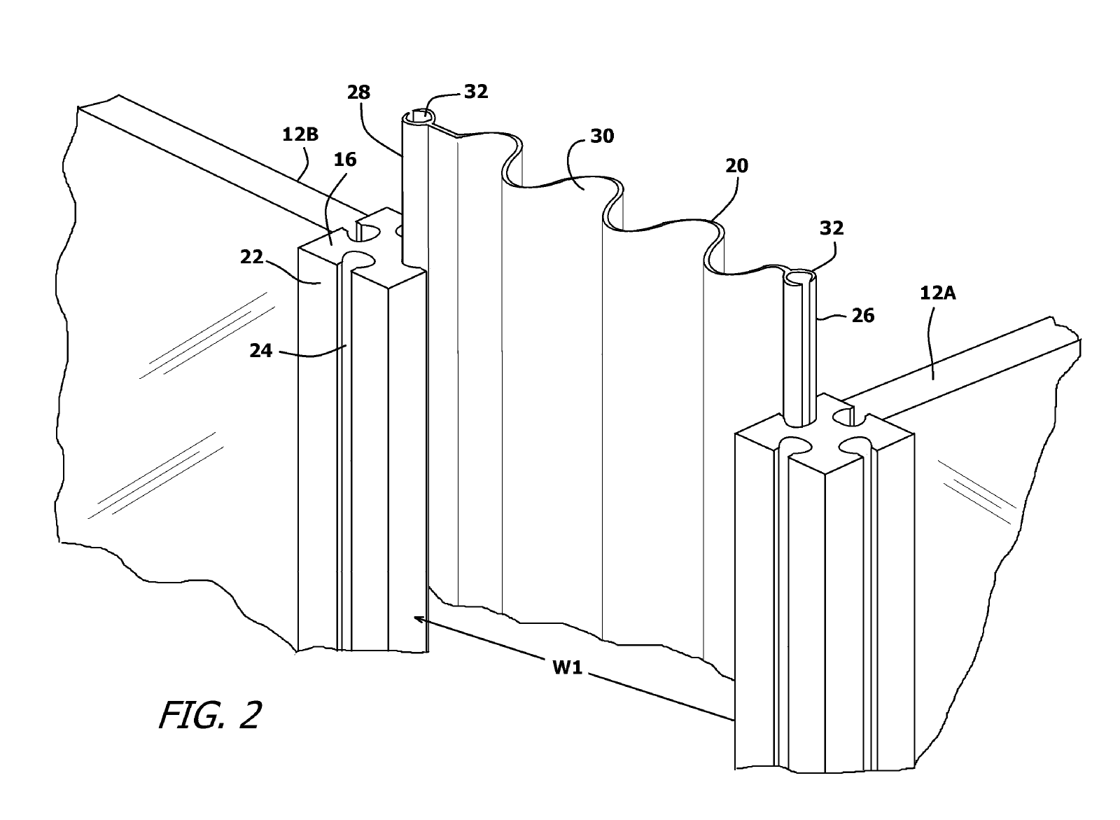

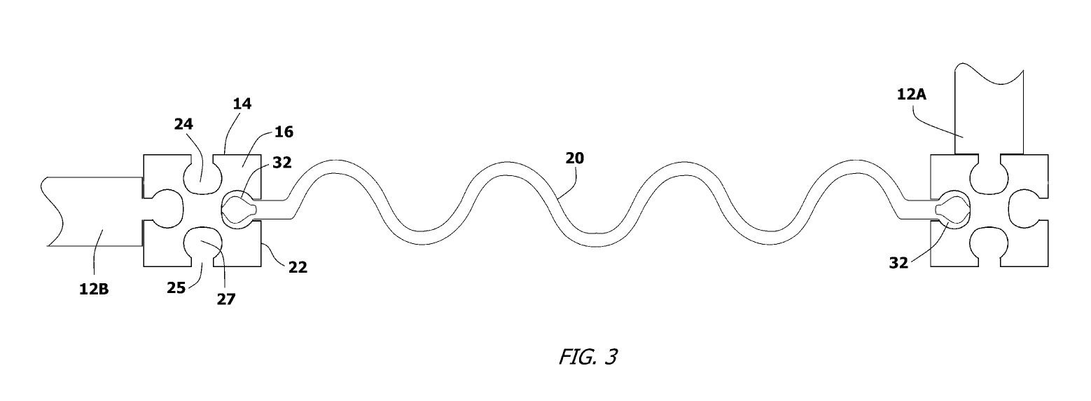

Referring to FIG. 2 in conjunction with FIG. 3, segments of two modular barrier panels 12A, 12B are shown. Each of the modular barriers 12A, 12B has a peripheral frame 14 that is comprised of frame elements 16. Each of the frame elements 16 has a generally square cross-sectional profile. That is, each frame element 16 has four flat side surfaces 22 that are generally equal in size.

A slot 24 is formed in each side surface 22 of each frame element 16. Each slot 24 is a T-slot or dovetail slot, wherein the slot 24 widens from a narrow entrance 25 on the face of the side surface 22 to a widened interior 27, as the slot 24 descends into the frame element 16. The slots 24 are typically used to anchor rigid connectors that extend between adjacent frame elements 16. However, in order for such rigid connectors to work, the slots 24 of two adjacent barrier panels 12A, 12B must have to be brought into abutment.

In the present invention system, the flexible connector panel 20 is provided. The flexible connector panel 20 has two parallel side edges 26, 28 that run the vertical length of the flexible connector panel 20. The flexible connector panel 20 has the same length as the modular barriers 12A, 12B it interconnects. In this manner, the flexible connector panel 20 is capable of covering the length of the entire joint between the modular barriers 12A, 12B.

The flexible connector panel 20 has a body 30 between the two side edges 26, 28 that is both solid and flexible. The body 30 can be generally planar. However, it is preferred that the body 30 have a serpentine profile, an accordion pleat profile, or is otherwise concertinaed so that the width W1 between the two side edges 26, 28 can be varied by applying opposing tension or compression to the side edges 26, 28.

The side edges 26, 28 of the flexible connector panel 20 each terminate with a flared border 32. The flared border 32 runs the length of the side edges 26, 28. Each flared border 32 is small enough to fit into the widened interior 27 of a slot 24, but is too large to pass through the narrow entrance 25 of the slot 24. The body 30 of the flexible connector panel 20 that is interposed between the flared borders 32 is preferably a panel of flexible plastic that has a gauge thickness small enough to enable the body 30 to pass through the narrow entrance 25 of any slot 24.

It will therefore be understood that the flexible connector panel 20 can join two modular barriers 12A, 12B together by sliding the flared borders 32 of the flexible connector panel 20 into the interior of the slots 24 on the modular barriers 12A, 12B to be joined. The body 30 of the flexible connector panel 20 extends through the narrow entrance 25 of the slots 24 and spans the width W1 between the modular barriers 12A, 12B. Due to the presence of the flared borders 32 in the slots 24, the side edges 26, 28 of the flexible connector panel 20 are mechanically connected to the opposing frame elements 12A, 12B along the entire length of the flexible connector panel 20. The body 30 of the flexible connector panel 20 is solid and creates an uninterrupted barrier that extends between the modular barriers 12A, 12B for the full length of the modular barriers 12A, 12B.

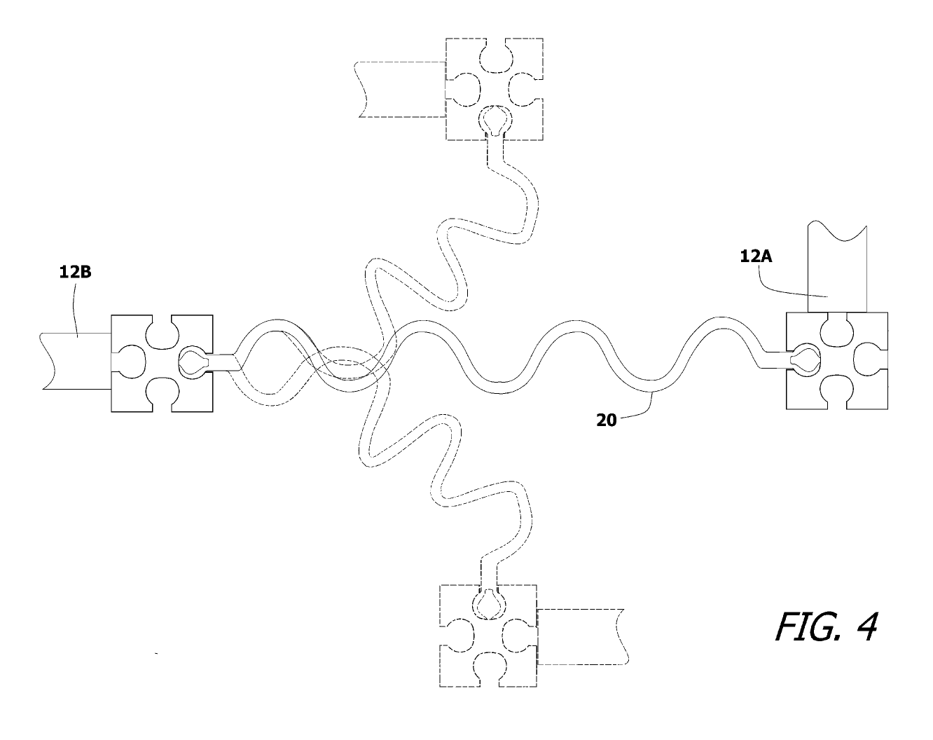

Referring to FIG. 4, it will be understood that since the flexible connector panel 20 is the only item interconnecting the two modular barriers 12A, 12B and the flexible connector panel 20 is flexible, the two modular barriers 12A, 12B are free to move relative each other. The two modular barrier panels 12A, 12B can be oriented at acute angle, obtuse angles or right angles. Throughout the range of movement, the flexible connector panel 20 elastically bends and maintains an uninterrupted barrier between the two modular barriers 12A, 12B. The interconnection between the modular barriers 12A, 12B enables the angle between the two modular barriers 12A, 12B to be adjusted without compromising the integrity of the overall barrier system. Likewise, the distance between the two modular barriers 12A, 12B can also be selectively adjusted as the flexible connector panel 20 is stretched and compressed.

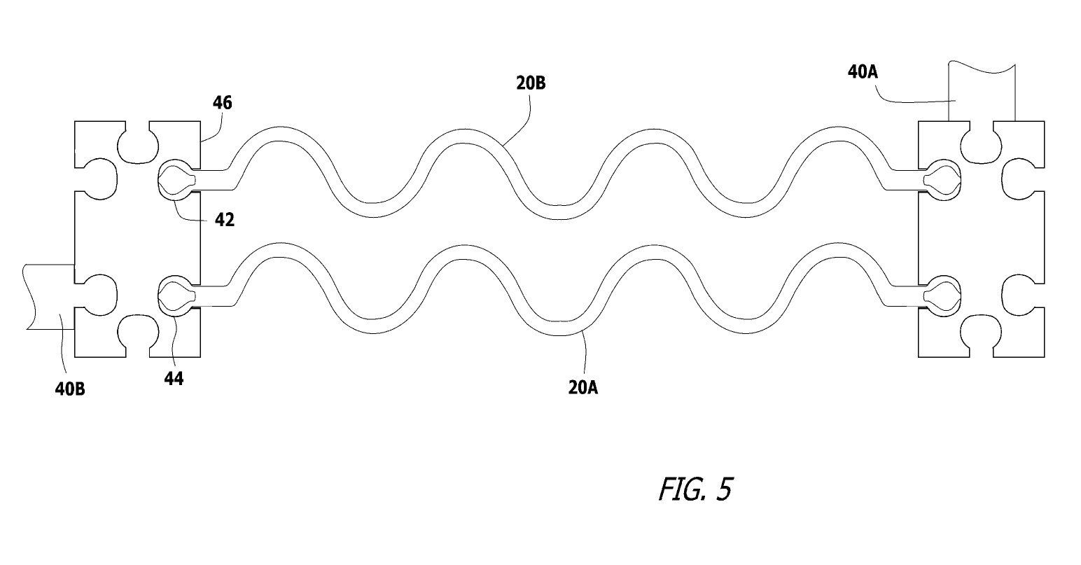

Referring to FIG. 5 an alternate application of the flexible connector panel 20 is shown. In this embodiment, there are opposing frame elements 40A, 40B that contain two sets of opposing slots 42, 44 on a flat face surface 46. In such a design, it will be understood that the two opposing sets of slots 42, 44 can be engaged by two flexible connector panels 20A, 20B. The two flexible connector panels 20A, 20B create a double-layered barrier. The two flexible connector panels 20A, 20B bend together, stretch together and compress together. It will therefore be understood that the presence of the two flexible connector panels 20A, 20B enables the two modular barriers 40A, 40B to be oriented at an acute angle, a right angle or an obtuse angle with respect to the other.

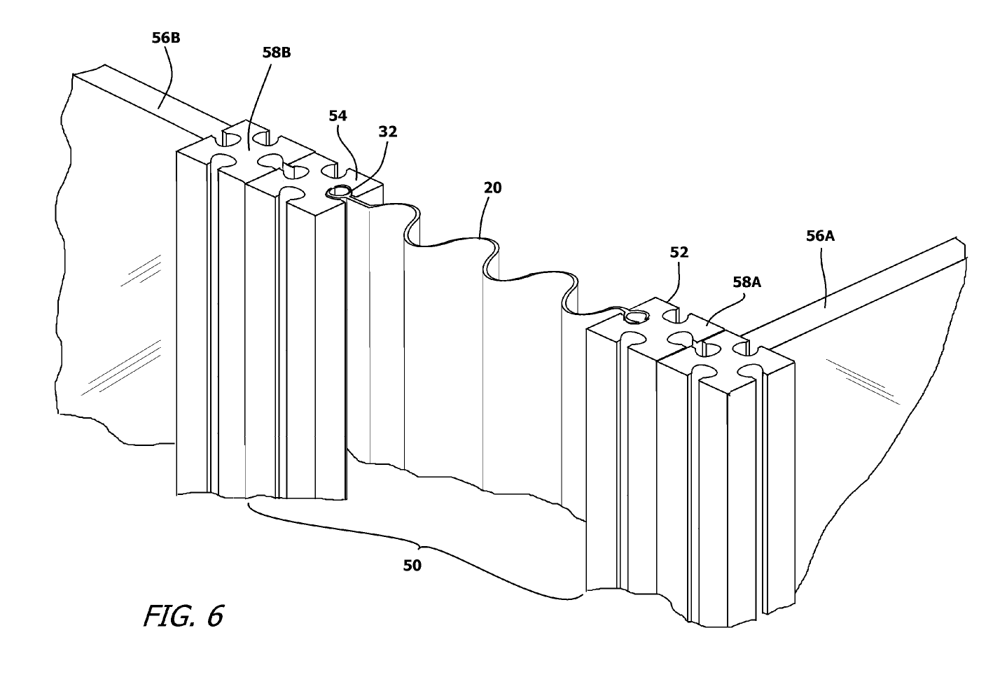

In the previous embodiments, the flexible connector panel 20 is shown directly interconnecting the peripheral frames of modular barriers. Referring to FIG. 6, an embodiment is shown wherein the modular barrier panel 20 is provided with its own frame elements 52, 54. Two frame elements 52, 54 are provided. The flared borders 32 on the side edges of the flexible connector panel 20 engage the frame elements 52, 54 in the same manner as previously described. The flexible connector panel 20 and its two side frame elements 52, 54 form a connector panel assembly 50.

During installation, the connector panel assembly 50 is placed between two modular barriers 56A, 56B. The frame elements 58A, 58B of the modular barriers 56A, 56B are brought into flush abutment with the frame elements 52, 54 of the connector panel assembly 50. The frame elements 58A, 58B of the modular barriers 56A, 56B are connected to the frame elements 52, 54 of the connector panel assembly 50 using traditional prior art connectors. The connector panel assembly 50 elastically bends and maintains an uninterrupted barrier between the two modular barriers 56A, 56B. The interconnection between the modular barrier panels 56A, 56B enables the angle between the two modular barrier panels 56A, 56B to be adjusted without compromising the integrity of the overall barrier system. Likewise, the distance between the two modular barriers 56A, 56B can also be selectively adjusted as the connector panel assembly 50 is stretched and compressed.

It will be understood that the embodiments of the present invention that are illustrated and described are merely exemplary and that a person skilled in the art can make many variations to those embodiments. All such embodiments are intended to be included within the scope of the present invention as defined by the claims.

1. A modular barrier system, comprising:
a first modular barrier having a first frame element at one end, wherein said first frame element has a first slot that extends along said first frame element, and wherein said first slot is accessible through a first narrowed entrance that extends along said first slot;
a second modular barrier having a second frame element at one end, wherein said second frame element has a second slot that extends along said second frame element, and wherein said second slot is accessible through a second narrowed entrance that extends along said second slot;
a panel having a flexible concertinaed body that extends from a first flared border along a first side edge to a second flared border along an opposite and parallel second side edge, wherein said flexible concertinaed body extends into said first slot of said first frame element and said second slot of said second frame element, wherein said first flared border locks said first side edge into said first slot and said second flared border locks said second side edge into said second slot, therein joining said first modular barrier to said second modular barrier.

2. (canceled)

3. The system according to claim 1, wherein said flexible panel has a width between said first side edge and said second side edge that is configured to be selectively adjustable by tensile and compressive forces.

4. The system according to claim 1, wherein said flexible panel has a width between said first side edge and said second side edge of between 10 centimeters and 40 centimeters.

5. A modular barrier system, comprising:
a first modular barrier;
a second modular barrier;
a first frame element having a first slot that extends along said first frame element;
a second frame element having a second slot that extends along said second frame element;
a panel having a flexible concertinaed body that extends from a first flared border along a first side edge to a second flared border along an opposite and parallel second side edge, wherein said body extends into said first slot of said first frame element and said second slot of said second frame element, wherein said first flared border locks said first side edge into said first slot and said second flared border locks said second side edge into said second slot, therein joining said first frame element to said second frame element;
wherein said first frame element is anchored to said first modular barrier and said second frame element is anchored to said second modular barrier.

6. (canceled)

7. The system according to claim 5, wherein said flexible panel has a width between said first side edge and said second side edge that is configured to be selectively adjustable by tensile and compressive forces.

8. The system according to claim 5, wherein said flexible panel has a width between said first side edge and said second side edge of between 10 centimeters and 40 centimeters.

9. A flexible connector panel for joining together two modular barriers, wherein each of the modular barriers has slotted frame elements, said flexible connector panel comprising:
a flexible concertinaed body having a first side edge and an opposite second side edge, wherein said first side edge and said second side edge terminate with enlarged flared borders that are locked into said slotted frame elements of said modular barriers, therein joining said modular barriers.

10. The panel according to claim 9, wherein said flexible concertinaed body is solid between said first side edge and said second side edge.

11. The panel according to claim 10, wherein said concertinaed body has a width between said first side edge and said second side edge that is selectively adjustable.

12. The panel according to claim 10, wherein said flexible panel has a width between said first side edge and said second side edge of between 10 centimeters and 40 centimeters.
